(19) United States
(12) Patent Application Publication
(10) Pub. No.: US 2022/0323796 A1
(43) Pub. Date: Oct. 13, 2022

(54) EMERGENCY EVACUATION TOOL

(71) Applicant: Aaron Richard William Blackwell, Quesnel (CA)

(72) Inventor: Aaron Richard William Blackwell, Quesnel (CA)

(21) Appl. No.: 17/224,205

(22) Filed: Apr. 7, 2021

(51) Int. Cl. A62B 3/00; B23D 45/16; B23D 45/00; B23D 59/00

(52) U.S. Cl. CPC A62B 3/00; B23D 45/16; B23D 45/003; B23D 59/006

(57) ABSTRACT

An emergency evacuation tool that is configured to be mounted within an operator cab of heavy equipment wherein the tool of the present invention is operable to facilitate evacuation of the cab by cutting through the safety cage surroundably present thereto. The present invention includes a housing having a motor and a power supply disposed in the interior volume thereof. A blade is present on one end of the housing wherein the blade is adjustable and axially aligned with the housing. The blade is surroundably mounted by a blade guard housing. The lower edge of the blade guard housing provides stabilization during use. A spark receiving member is secured to the blade guard housing. The emergency evacuation tool is releasably secured to a mounting case that is electrically coupled to the heavy equipment. The housing includes at least one handle that is rotatable about the housing.

### FIELD OF THE INVENTION

The present invention relates generally to emergency equipment, more specifically but not by way of limitation, an emergency evacuation tool that is configured to be operably mounted within a cab of heavy equipment and functions to assist an operator to escape in the event of an emergency.

### BACKGROUND

As is known in the art, there are many different types of heavy equipment that are utilized in various fields such as but not limited to construction, mining and logging. The heavy equipment in each field is specialized to perform the desired tasks and operation of this equipment requires a skilled operator. The operator typically sits in a cab or similar structure on the machine in order to facilitate the operation of the equipment. These cabs have specialized controls for operation of the vehicle and many of these cabs are enclosed. Enclosed cabs can be designed to provide comfort for the operator but are primarily designed for the safety of the occupant.

The logging industry employs many specialized types of heavy equipment such as but not limited to skidders, harvesters and swing machines. During use of this equipment the operator is disposed within the cab. Much of the terrain that these machines are utilized in is very rough and presents many challenges during operation of the equipment. As the logging industry is quite dangerous, the cabs on the heavy equipment utilized for logging are well protected in order to provide safety for the operator. The cabs are often protected with steel cages and many further have Lexan or similar material all being operable to inhibit a log or other debris from penetrating into the cabin. One issue with the equipment that has the aforementioned type of cabs is the escapability. In the event of an emergency such as but not limited to a fire or equipment rollover, the operator may have a difficult time escaping the cab due to the structure of the steel and Lexan.

It is intended within the scope of the present invention to provide an emergency escape tool that is mounted within the operator's cab wherein the present invention can facilitate the evacuation of an operator in the event of an emergency.

### SUMMARY OF THE INVENTION

It is the object of the present invention to provide an emergency evacuation tool disposed in the operator cab of heavy equipment wherein the present invention includes a mounting case in the cab of the heavy equipment.

Another object of the present invention is to provide a tool operable to facilitate the cutting of steel, Lexan and other materials disposed around the operator cab of heavy equipment wherein the present invention includes a housing having handles operably coupled thereto.

A further object of the present invention is to provide an emergency evacuation tool disposed in the operator cab of heavy equipment wherein the housing of the present invention includes a power supply disposed therein.

Still another object of the present invention is to provide a tool operable to facilitate the cutting of steel, Lexan and other materials disposed around the operator cab of heavy equipment that further includes an adjustable rotary blade capable of cutting steel, Lexan and other similar materials.

An additional object of the present invention is to provide an emergency evacuation tool disposed in the operator cab of heavy equipment wherein the blade has a housing covering a portion thereof wherein the housing has a generally flat bottom edge.

Yet a further object of the present invention is to provide a tool operable to facilitate the cutting of steel, Lexan and other materials disposed around the operator cab of heavy equipment wherein the housing has releasably secured thereto a spark receptacle.

Another object of the present invention is to provide an emergency evacuation tool disposed in the operator cab of heavy equipment wherein the mounting case can be electrically coupled to the electrical system of the heavy equipment.

An alternate object of the present invention is to provide a tool operable to facilitate the cutting of steel, Lexan and other materials disposed around the operator cab of heavy equipment wherein the rotary blade can be adjusted to cut a depth of five inches.

Still a further object of the present invention is to provide an emergency evacuation tool disposed in the operator cab of heavy equipment wherein the mounting case further includes an additional power supply.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagrammatic view of an embodiment of the present invention disposed in its mounting case; and

FIG. 2 is a perspective view of an embodiment of the present invention.

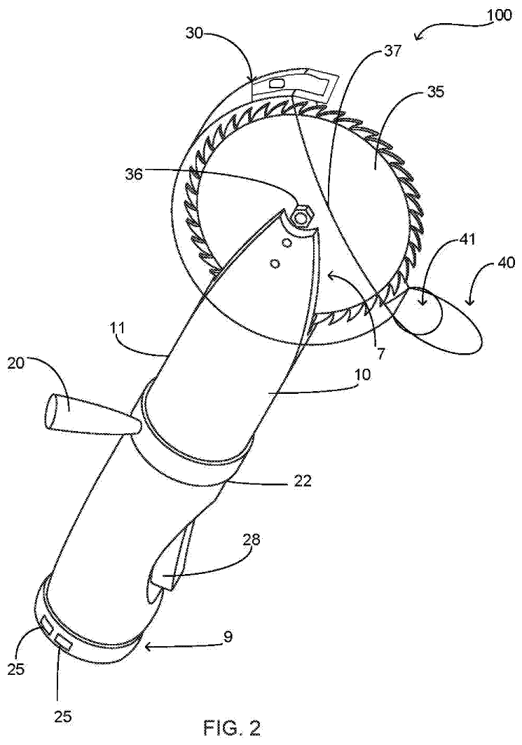

### DETAILED DESCRIPTION

Referring now to the drawings submitted herewith, wherein various elements depicted therein are not necessarily drawn to scale and wherein through the views and figures like elements are referenced with identical reference numerals, there is illustrated an emergency evacuation tool 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring to the drawings submitted herewith, the emergency evacuation tool 100 includes a housing 10. The housing 10 is manufactured from a suitable durable material such as but not limited to plastic. The housing 10 includes an interior volume (not particularly illustrated herein) that is hollow so as to house a power supply and a motor. The housing 10 of the embodiment illustrated herewith is generally cylindrical in shape but it should be understood within the scope of the present invention that the housing 10 could be formed in alternate sizes and shapes. It is preferred within the scope of the present invention that the housing 10 is generally compact so as to facilitate storage and use for the intended purpose of the emergency evacuation tool 100.

A handle 20 is movably secured to the exterior of the housing 10. The handle 20 is mounted utilizing support ring member 22 wherein the support ring member 22 facilitates a rotational movement of the handle 20 around the housing 10. The handle 20 is perpendicular to the support ring member 22 and extends outward therefrom. The handle 20 is configured to be rotatably positioned about the housing 10 at least one hundred and eighty degrees. While not particularly illustrated herein, it is contemplated within the scope of the present invention that the housing 10 could have an additional handle secured thereto. An additional handle would be fixed and secured proximate an upper edge 11.

Proximate the bottom end 9 of the housing 10 are the power supply engagement members 25. The power supply engagement members 25 are operable to electrically couple the power supply disposed within the housing 10 to the mounting case 50. The power supply engagement members 25 are manufactured from a conductive material and it should be understood within the scope of the present invention that the power supply disposed within the housing 10 is a lithium ion battery or suitable equivalent. A power button 28 is operably coupled to the housing 10 and is utilized to activate the emergency evacuation tool 100. While a trigger style power button 28 is illustrated herein, it should be understood within the scope of the present invention that the power button 28 could be provided in alternate forms.

Secured to the housing 10 proximate the upper end 7 thereof is a blade guard housing 30. The blade guard housing 30 is comprised of walls 31 that are contiguously formed wherein the walls 31 form a cavity 32 that is of suitable size to accommodate blade 35 therein. The blade guard housing 30 is surroundably present to the blade 35 and functions to protect a user of the emergency evacuation tool 100 from the blade 35 and debris during use of the emergency evacuation tool 100. The blade guard housing 30 is semi-annular in shape and is shaped so as to provide substantial coverage of the blade 35. The blade guard housing 30 is formed so as to have a substantially flat bottom edge 37. The flat bottom edge 37 being present on both sides of the blade 35 is designed so as to facilitate the placement thereof adjacent the material being cut such as steel of Lexan. The bottom edge 37 being present on opposing sides of the blade 35 provides an element that offers a stabilization of the blade 35 and as such the emergency evacuation tool 100 during utilization thereof. Releasably secured to the blade guard housing 30 is a spark receiving member 40. The spark receiving member 40 is configured to capture hot metal fragments as the hot metal fragments fly off the blade 35 when the emergency evacuation tool 100 is cutting metal. The spark receiving member 40 includes an interior volume 41 sufficient in size to receive the hot metal fragments therein. The spark receiving member 40 is manufactured from a flexible fire resistant material such as but not limited to Nomex. It should be understood within the scope of the present invention that the spark receiving member 40 could be releasably secured utilizing various suitable fasteners.

The blade 35 is a rotary blade that is manufactured to cut both metal as well as Lexan or similar material as these materials often are present around the cab of heavy equipment in the logging industry. The blade 35 is movably mounted to the housing 10 using fastener 36 wherein the blade 35 can be adjusted so as to provide alternate depths of cuts. Blade 35 is axially aligned with the housing 10 so as to provide effective positioning thereof during use. While no depths are particularly required, it is preferred within the scope of the present invention that the blade 35 be adjustable to cut at a depth of five inches.

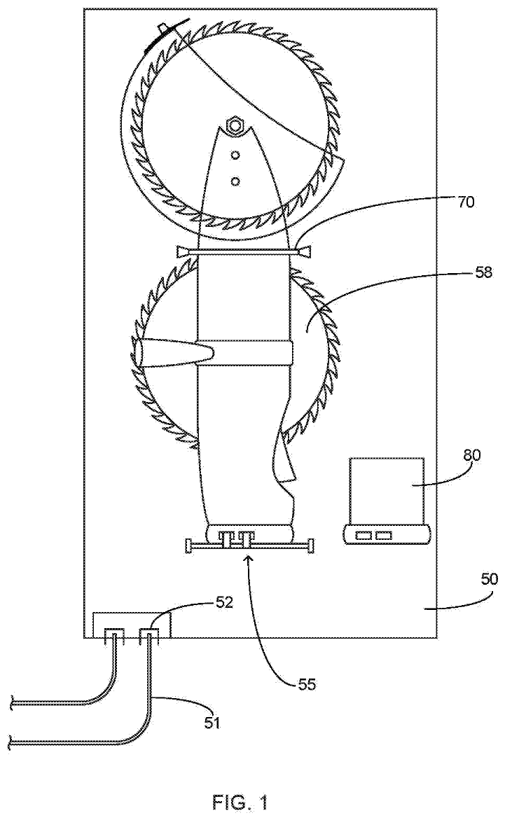

Illustrated herein is FIG. 1 submitted herewith is the mounting case 50. The mounting case 50 is configured to be mounted inside the operator cab of heavy equipment utilizing suitable durable fasteners. The mounting case 50 is manufactured from a durable material such as but not limited to plastic. The mounting case 50 is electrically coupled to the electrical system of the heavy equipment in which the mounting case 50 is installed. Wires 51 and connectors 52 facilitate the electrical coupling of the mounting case 50 to the heavy equipment. The mounting case 50 includes electrical couplers 55 which are configured to electrically couple to the power supply engagement members 25 in order to facilitate charging of the power supply disposed within the housing 10. The mounting case 50 further includes an additional blade 58 that is stored in a receptacle of mateable size and shape. A clamp member 70 is present and is configured to releasably secure the emergency evacuation tool 100 within the mounting case 50. The clamp member 70 in a preferred embodiment is a metal bar secured with fasteners but it should be understood within the scope of the present invention that the clamp member 70 could be provided in alternate embodiments.

The mounting case 50 further includes a second power supply 80. The second power supply 80 is electrically coupled to the mounting case 50 so as to ensure a full charge thereof. While the embodiment of the emergency evacuation tool 100 utilizes cordless power supplies, it is contemplated within the scope of the present invention that the emergency evacuation tool 100 could be hard wired to the mounting case 50 so as to receive power from the electrical system of the heavy equipment. This could be provided in addition to the power supplies and as such provide a first power supply technique and a second power supply technique. While not particularly illustrated herein, it is contemplated within the scope of the present invention that the mounting case 50 could have disposed therein various safety equipment such as but not limited to safety glasses and masks.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

1. An emergency evacuation system operable to assist in exiting an operator cab of heavy equipment, wherein the emergency evacuation system includes an emergency evacuation cutting tool configured to be used within the operator cab, the emergency evacuation cutting tool comprises:
a housing, said housing having an interior volume, said interior volume having a motor and a power supply disposed therein, said housing having a handle end and an blade end;
a blade, said blade being rotatably secured to said blade end of said housing, said blade being in axial alignment with said housing, said blade extending outward from said blade end of said housing, said blade being adjustably mounted to provide alternate depths of cuts;
a blade guard housing, said blade guard housing having a plurality of walls integrally formed to create a cavity, said cavity having the blade disposed therein, said blade guard housing configured to surroundably mount a portion of the blade, said blade guard housing having a lower edge, wherein the lower edge of the blade guard housing is configured to be placed adjacent to a material being cut by the emergency evacuation tool and said lower edge comprising a lockable adjustable guard operative to adjust the depth of cut for said blade.

2. The emergency evacuation system operable to assist in exiting an operator cab of heavy equipment as recited in claim 1, and further including a mounting case, wherein the mounting case is configured to be disposed within the cab, said mounting case operable to have the emergency evacuation tool releasably secured therein.

3. The emergency evacuation system operable to assist in exiting an operator cab of heavy equipment as recited in claim 2, wherein the mounting case is configured to be electrically coupled to an electrical system of the heavy equipment.

4. The emergency evacuation system operable to assist in exiting an operator cab of heavy equipment as recited in claim 3, and said tool further including a spark receiving member, said spark receiving member releasably secured to said blade guard housing, said spark receiving member having an interior volume operable to capture metal fragments generated by the blade.

5. The emergency evacuation system operable to assist in exiting an operator cab of heavy equipment as recited in claim 4, wherein said housing further includes a handle, said handle being rotatable about said housing, said handle extending outward from said housing and being perpendicular thereto.

6. The emergency evacuation system operable to assist in exiting an operator cab of heavy equipment as recited in claim 5, and said tool further including a support ring member, said support ring member being circumferentially secured to said housing, said handle being secured to said support ring member, said support ring member being rotatably secured to said housing so as to provide rotational positioning of said handle relative to said housing.

7. The emergency evacuation system operable to assist in exiting an operator cab of heavy equipment as recited in claim 6, wherein said mounting case further includes a clamp member, said clamp member operable to releasably secure the emergency evacuation tool in said mounting case.

8. The emergency evacuation system operable to assist in exiting an operator cab of heavy equipment as recited in claim 7, wherein said blade is adjustably mounted so as to provide a cutting depth of up to five inches.

9. The emergency evacuation system operable to assist in exiting an operator cab of heavy equipment as recited in claim 8, wherein said housing further includes power supply engagement members, said power supply engagement members being present on said lower end of said housing, said power supply engagement members configured to facilitate electrical coupling of the emergency evacuation tool to the mounting case.

10. The emergency evacuation system operable to assist in exiting an operator cab of heavy equipment as recited in claim 9, and further including electrical couplers, said electrical couplers being mounted in said mounting case, said electrical couplers configured to electrically couple with said power supply engagement members.

11. The emergency evacuation system operable to assist in exiting an operator cab of heavy equipment as recited in claim 10, wherein said mounting case further has a second power supply, said second power supply being electrically coupled to said mounting case.
